(19) United States
(12) Patent Application Publication
(10) Pub. No.: US 2009/0127520 A1
(43) Pub. Date: May 21, 2009

(54) Lithium metal oxide compositions

(76) Inventors: Pamela Whitfield, Ottawa (CA); Isobel Davidson, Orleans (CA)

Correspondence Address: NATIONAL RESEARCH COUNCIL OF CANADA;1200 MONTREAL ROAD, BLDG M-58, ROOM EG12, OTTAWA, ONTARIO, K1A 0R6, CA

(21) Appl. No.: 12/289,371

(22) Filed: Oct. 27, 2008

Related U.S. Application Data
(63) Continuation-in-part of application No. 10/558,445, filed on Nov. 6, 2006, now abandoned.
Application No. 10/558,445 is a continuation-in-part of application No. PCT/CA2004/000770, filed on May 27, 2004.
(60) Provisional application No. 60/473,476, filed on May 28, 2003.

(51) Int. Cl. H01B 1/08

(52) U.S. Cl. 252/519.15; 252/519.1

(57) ABSTRACT

The invention disclosed is a composition of a single-phase solid solution of LiMnO₂ and LiMO₃ having a Li₂MnO₃-type crystallographic structure and the general formula Li_{i+y/3}Mn_{2y/3}M_{(1-y)}O₂, wherein 0<y<1, manganese is in the 4+ oxidation state, M is one or more transition metal or other cations which have an appropriate ionic radii to be inserted into the structure without unduly disrupting it, but not solely Ni or Cr, e.g. one or more the first row transition metals: Ti, V, Cr, Mn, Fe, Co, Ni or Cu, or other specific other cations: Al, Mg, Mo, W, Ta, Si, Sn, Zr, Be, Ca, Ga, and P, and M has an average oxidation state of +3. Also disclosed are compositions and structures of the materials e.g in the form of a positive electrode for a non-aqueous lithium cell or battery.

### CROSS-REFERENCE TO RELATED APPLICATION

This application is a Continuation-in-part of US National stage application of PCT/CA2004/000770, filed May 27, 2004, which claims the benefit of U.S. provisional application Ser. No. 60/473,476, filed May 28, 2003.

### BACKGROUND OF THE INVENTION

This invention relates to lithium metal oxide compositions, and in particular to lithium-metal-oxide compositions and structures formed as single-phase solid solutions of Li₂MnO₃ and LiMO₂ having an Li₂MnO₃-type crystal structure, used for example as positive electrodes for non-aqueous lithium cells and batteries.

The theoretical capacity of the layered lithium metal oxides typically used as cathodes in lithium ion batteries is much higher than the capacities achieved in practice. For lithium ion battery cathodes, the theoretic capacity is the capacity that would be realised if all of the lithium could be reversibly cycled in and out of the structure. For example, LiCoO₂ has a theoretical capacity of 274 mAh/g but the capacity typically achieved in an electrochemical cell is only about 160 mAh/g, equivalent to 58% of theoretical. Somewhat better capacities of up to about 180 mAh/g have been observed by the partial substitution of Co³⁺ with other trivalent cations such as nickel [Delmas, Saadoune and Rougier, J. Power Sources, Vol. 43-44, pp. 595-602, 1993].

Materials in the more complex Co, Ni, Mn systems, and in particular the composition LiCo_{1/3}Ni_{1/3}Mn_{1/3}O₂, have been studied extensively by Ohzuku. He has reported capacities of approximately 200 mAh/g with good thermal stability [Ohzuku era/, U.S. patent application Ser. No. 10/242,052].

Other related references on R-3m structures of LiMO₂ in which M is a combination of Co, Ni and Mn include:
Yabuuchi and Ohzuku, Journal of Power Sources, Volumes 119-121, 1 Jun. 2003, Pages 171-174.
Wang et al, Journal of Power Sources, Volumes 119-121, 1 Jun. 2003, Pages 189-194, and
Lu et al, Electrochemical and Solid State Letters, v4 (2001), A200-203.

Multi-phase materials formed from mixtures of Li₂MO₃ and LiM′O₂ in which M is Mn⁴⁺ or Ti⁴⁺ or Zr⁴⁺ and M′ is a first row transition metal cation or combination of transition metal cations with an average oxidation state of 3+ have been proposed for application as positive electrode materials for lithium ion batteries [Thackeray et al U.S. Pat. No. 6,677,082 B2 and U.S. Pat. No. 6,680,143 B2] However, the discharge capacities reported for these materials were between about 110 mAh/g and 140 mAh/g even after charging to voltages greater than 4.4 volts.

Exceptionally high charge and discharge capacities up to about 280 and 230 mAh/g, respectively, have been reported for solid solutions of LiCrO₂ and Li₂MnO₃ [PCT Internat. Pub. # WO 01.28010 A1 and U.S. Pat. No. 6,735,110 B1]. However, for these materials, it is known that a reversible Cr(III)-Cr(VI) redox couple provides the exceptional capacity [Balasubramanian et al, J. Electrochem. Soc., vol. 149 (2) A176-A184 (2002) and Ammundsen et al, J. Electrochem. Soc, vol. 149 (4) A431-A436 (2002)].

Layered structures of composition Li[Li_{(1/3-2x/3)}NiₓMn_{(2/3-x/3)}]O₂ (with x=0.41, 0.35, 0.275, and 0.2) formed by sol gel synthesis containing manganese as Mn4+ and Ni in the 2+ oxidation state have also shown exceptionally large capacities. In particular discharge capacities up to 200 mAh/g at room temperature and 240 mAh/g at 55° C., were observed for some compositions of Li[Li_{(1/3-2x/3)}NiₓMn_{(2/3-x/3)}]O₂ on cycling between 2.5 and 4.6 volts [ref. Shin, Sun and Amine, Journal of Power Sources, v112 (2002) 634-638]. These materials can be viewed as solid solutions of Li₂MnO₃ and NiO. Similarly, Lu and Dahn investigated compositions Li[Li_{(1/3-2x/3)}NiₓMn_{(2/3-x/3)}]O₂ (with x=⅙, ¼, ⅓, 5/12 and ½) having a O3 crystal structure [ref. J. Electrochem. Soc. v149 (2002), A778-A791, J. Electrochem. Soc. v149 (2002) A815-A822 and US 2003/0027048 A1] and demonstrated that reversible capacities near 230 mAh/g could be achieved from certain compositions of Li[Li_{(1/3-2x/3)}NiₓMn_{(2/3-x/3)}]O₂ when the cells were charged to 4.8 volts. These materials are solid solutions of Li₂MnO₃ and NiO. The capacities observed on cycling these same materials between 3.0 and 4.4 volts were much lower, varying with composition from about 85 to 160 mAh/g. An in-situ transformation was found to occur on charging Li[Li_{(i/3-2x/3)}NiₓMn_{(2/3-x/3)}]O₂ to voltages greater than 4.4 volts. The resulting materials were found to have a much higher reversible capacity.

Zhang et al reported the synthesis and electrochemical properties of solid solutions of Li₂MnO₃ and LiNiO₂ prepared from metal acetates [ref. J. Power Sources vol. 110, 57-64 (2002)]. The authors did not note any anomalous capacities in their materials on cycling between 3.0 and 4.5V.

U.S. patent application Ser. No. 09/799,935 of Paulsen, Kieu and Ammundsen discloses single phase materials of formula Li[LiₓCo_{y}A_{1-x-y}]O₂ where A=[Mn_{z}Ni_{1-z}] having the layered R-3m crystal structure. The electrochemical cell cycling was limited to between 2.0 and 4.4.volts and no anomalously high capacities were noted.

Dahn and Lu investigated compositions of Li[Ni_{y}Co_{1-y}Mn_{y}]O₂ having the O3 crystal structure cycled between 2.5 and 4.8 volts [ref. US 2003/0027048 A1 and J. Electrochem. Soc. vol. 149 (6) A778-A791 (2002)]. These materials showed quite good, but not evidently anomalous capacities.

Solid solutions of Li₂MnO₃ and LiCoO₂ and Li₂O were prepared and studied by Numata, Sakaki and Yamanaka [Solid State Ionics, vol. 117 (1999) 257-263] and Numata and Yamanaka [Solid State Ionics, vol. 118 (1999) 117-120]. Cathodes prepared from these compounds were cycled between voltage limits of 3.0 and 4.3 volts. These materials did not show high capacities and, in fact, the capacities decreased with increasing Li₂MnO₃ content as would normally have been expected by those skilled in the art.

In all previous reports of anomalously high discharge capacities being achieved after charging to voltages greater than 4.4 volts, the materials reported were described as layered 03 or R-3m structures containing Mn in the 4+ oxidation state and either Ni in the 2+ oxidation state or Cr in the 3+ oxidation state. More typically charging to such high voltages is extremely detrimental to the electrochemical performance of the cathode material.

In materials containing either Cr³⁺ or Ni²⁺ oxidation involving more that one electron transfer per Cr or Ni is possible. For solid solution phases of Li₂MnO₃ and LiCrO₃ the reversible oxidization of Cr³⁺ to Cr⁶⁺ accounts for the unusually large reversible capacity. For solid solutions of LiMnO₃ and NiO, the reversible oxidation of Ni between Ni²⁺ and Ni⁴⁺ can not fully account for the additional capacity. It has been proposed by Lu and Dahn [J. Electrochem. Soc, vol. 149 (2002) A815-A822] that the added capacity in solid solution phases of Li₂MnO₃ and NiO could be accounted for by irreversible loss of oxygen and lithium.

### SUMMARY OF THE INVENTION

According to the present invention, we provide a broad range of novel lithium metal oxide compositions formed as single-phase materials having a Li₂MnO₃-type crystal structure, exhibiting anomalously large reversible capacities after charging at least once to voltages greater than about 4.4 volts versus Li/Li⁺. A suitable upper voltage range is 5.2 V, with an upper voltage range of 4.8 V being preferred and with an upper voltage range of 4.6 V being most preferred. Although materials of similar composition have been prepared by others, for example Thackeray et al [U.S. Pat. No. 6,677,082 B2 and U.S. Pat. No. 6,680,143 B2], the single-phase Li₂MnO₃-type crystal structure of the materials disclosed herein imparts unique and much improved electrochemical behaviour.

In particular, in this invention it is provided that single-phase solid solutions of Li₂MnO₃ and LiMO₂, in which M is not solely Ni or Cr, having a LiMnO₃-type crystal structure, exhibit unexpectedly large reversible capacities after being severely oxidized by charging to high voltages.

In one embodiment of the invention, M is neither Ni²⁺ nor Cr³⁺ taken alone, and when M is a single cation, it is in the 3+ oxidation state.

This invention further provides new single phase materials formed as solid solutions of Li₂MnO₃ and LiMO₂ having a Li₂MnO₃-type crystal structure wherein M is one or. more transition metal or other cations having appropriate sized ionic radii to be inserted into the structure without unduly disrupting it.

According to one aspect of this invention, new single phase materials formed as solid solutions of Li₂MnO₃ and LiMO₂ having a Li₂MnO₃-type crystal structure, wherein Mn is Mn⁺⁴ and M is one or more transition metal or other cations having an average oxidation state of 3+ and an appropriate sized ionic radii to be inserted into the structure without unduly disrupting it, are provided

According to another aspect of this invention, new materials comprising materials formed as single-phase solid solutions of Li₂MnO₃ and LiMO₂ having an Li₂MnO₃-type crystal structure, wherein Mn is Mn⁺⁴ and M is one or more transition metal or other cations having an average oxidation state of 3+ and an appropriate sized ionic radii to be inserted into the structure without unduly disrupting it, but not solely Ni or Cr, are provided.

According to yet another aspect of this invention, it is disclosed that materials formed as single-phase solid solutions of Li₂MnO₃ and LiMO₂ having an Li₂MnO₃-type crystal structure, wherein M is one or more metal cations are useful as positive electrodes in a non-aqueous lithium cell, such as a lithium ion cell or battery.

Furthermore, this invention provides that materials formed as single-phase solid solutions of Li₂MnO₃ and LiMO₂ having an Li₂MnO₃-type crystal structure, wherein Mn is Mn⁺⁴ and M is one or more transition metal or other cations having an average oxidation state of 3+ and an appropriate sized ionic radii to be inserted into the structure without unduly disrupting it, but not solely Ni or Cr, exhibit unusually large reversible capacities after being oxidized at least once to voltages greater than 4.4 volts versus Li/Li⁺ in-situ in an electrochemical cell by charging or ex-situ by chemical oxidation.

Solid solution phases of Li₂MnO₃ and LiMO₂ are most commonly described as having the general formula xLi₂MnO₃:(1−x)LiMO₂. However, alternatively equivalent, and simpler descriptions, of the general formula for solid solution phases of Li₂MnO₃ and LiMO₂ can be made. For example, if we were to reformulate Li₂MnO₃ to an equivalent description obtained by multiplying by ⅔, we would obtain the formula Li_{4/3}Mn_{2/3}O₂. Then solid solution phases of Li_{4/3}Mn_{2/3}O₂ and LiMO₂ can be described as having a general formula of yLi_{4/3}Mn_{2/3}O₂:(1−y)LiMO₂. By simply multiplying this out, a general formula of Li_{i+y/3}Mn_{2y/3}M_{(i-y)}O₂ is obtained. A further equivalent description of the general formula can be written as Li[Li_{y/3}Mn_{2y/3}M_{(1-y)}]O₂

According, to one embodiment of the invention, single-phase solid solutions of LiMnO₃ and LiMO₂, having a Li₂MnO₃-type crystal structure of general formula Li_{1+y/3}Mn_{2y/3}M_{(1-y)}O₂ wherein 0<y<1, Mn is Mn⁴⁺, and M is one or more transition metal or other metal cations having appropriate ionic radii to be inserted in to the structure without unduly disrupting it, but not solely Ni or Cr, are provided.

In some embodiments of the invention, the cation M should be chosen from one or more cations that can be inserted into the structure without unduly disrupting it, with the exception that it should not be solely Ni or Cr. These choices are based on “ionic radii”, i.e. whether they can fit into the structure without unduly disrupting it.

In some embodiments of the invention, the cation M can include one or more suitable cations in any ratio that provides an average oxidation state of 3+. In the case of M comprising two cations: M¹ and M², the ratio of M¹:M² can vary from about 1:9 to 9:1, with ratios between 1:4 to 4:1 being preferred and ratios between 1:3 to 3:1 being most preferred. Similarly, in the case of M comprising 3 cations: M¹, M² and M³, mixtures in any ratio that has an average oxidation state of 3+ is preferred, and ratios of approximately 2:1:1, 1:1:1 and 2:1.5:0.5 are most preferred.

Cations that have been found as possible fits into similar structures include: all of the first row transition metals, Al, Mg, Mo, W, Ta, Si, Sn, Zr, Be, Ca, Ga, and P. The preferred cations include the transition metals of the first row, such as Ti, V, Cr, Fe, Co, Ni and Cu, and other metals such as Al, Mg, Mo, W, Ta, Ga and Zr. The most preferred cations are Co, Ni, Ti, Al, Cu, Fe and Mg.

According to one embodiment of the invention, a single-phase solid solutions of LiMnO₃ and LiMO₂, having a Li₂MnO₃-type crystal structure of general formula Li_{i+y/3}Mn_{2y/3}M_{(1-y)}O₂ wherein y=0.6, Mn is Mn⁴⁺, and M is one or more transition metal or other metal cations having appropriate ionic radii to be inserted in to the structure without unduly disrupting it, but not solely Ni or Cr. In this embodiment, the general formula can be written as

Li_{1.2}Mn_{0.4}Ni_{0.4-x}CoₓO₂ (0.1≦x≦0.4),

the composition of this formula wherein x=0 is known per se.

In preferred compositions, y is in the range 0.18≦y≦0.82.

In more preferred compositions, 0.33≦y≦0.82.

In most preferred compositions, 0.47≦y≦0.82.

According to yet another aspect of the invention, a process for making the novel lithium metal oxide materials of general formula Li_{1+y/3}Mn_{2y/3}M_{(1-y)}O₂, where 0<y<1 and M is one or more transition metal or other cations having appropriate ionic radii to be inserted in to the structure without unduly disrupting it, is provided, comprising preparation of high lithium content precursors using a modification of the well known “sucrose method” from that originally reported in the literature by Das, [Materials Letters, v47 (2001), 344-350], and later by Mitchell et al [Journal of Materials and Science letters, v21 (2002) 1773-1775, the Disclosures of which are Incorporated Herein by Reference. In this method, metal ions were added in the form of water-soluble salts, such as nitrate salts, oxalate salts, sulphate salts, halide salts or acetate salts in the required stoichiometries. Water-soluble nitrate salts, acetate salts and oxalate salts are preferred. Sucrose was added in aqueous solution in a molar excess amount e.g. calculated to be a 4:1 molar excess over the metal cations. After dissolution of the solids in an aqueous solvent e.g. de-ionized water, a strong acid e.g. concentrated nitric acid, was added until the pH of the solution was ≦1. The solution was then heated e.g. on a hotplate, to evaporate the water. Once the solution started to become viscous, the heat was increased to decompose the salts and eventually char the sucrose. This process produces a lot of gas and results in the viscous mixture foaming up. Heating was continued until the char dried out and eventually combusted. Combustion is slow in this process as opposed to the rapid process with glycine for example. Once combustion has finished, the ashes were collected and used as a precursor for further treatment. Typically, the precursors were fired e.g. in flowing air at high temperature e.g. 740, 800 or 900° C. for 6 hours.

The compositions according to the invention exhibit unusually high reversible capacity, in excess of the conventional theoretical capacities that are calculated on the basis of conventional views on the accessible range of oxidations states. For example, it is conventionally assumed that neither Mn4+ nor O₂₋ will be oxidized under the conditions of the application. The capacities obtained from these materials is beyond that calculated using such assumptions. It is also possible to substitute other cations including electrochemically inert Al³⁺ and still obtain high capacities and stable cycling (example 5). Furthermore, the Al-doping had the effect of increasing the average discharge voltage of the material. The mechanism for the production of these anomalous capacities seems to lie with combination of the Li₂Mn03-type crystal structure and the Mn⁴⁺, content imparting unusual stability to these materials from undesirable reactions with the electrolyte at high voltages.

Our examples show that a broad range of chemical compositions formed as single phase solid solutions of Li₂MnO₃ and LiMO₂ having the Li₂MnO₃-type crystal structure have exceptionally large reversible capacities. Most of these materials have never been reported previously.

These novel materials produced capacities that cannot be explained conventionally. Results also indicate an unusual ability to tune the discharge voltage through relatively small variations in the composition.

Some of the more complex novel materials have 5 different species sharing a single crystallographic site. Many standard synthetic techniques would not provide sufficient homogeneity to achieve a single-phase material. The synthetic techniques used to date to achieve this level of homogeneity are a modified “sucrose-method” based dispersion/combustion technique and a high energy ball milling approach.

### BRIEF DESCRIPTION OF THE DRAWINGS

FIG. 1. Ternary phase diagram for the LbMnO₃—LiCoO₂—LiNiO₂ system. The diamonds represent single phase materials synthesised and characterised.

FIG. 2. X-ray diffraction patterns for materials in the Li₂MnO₃—LiNi_{0.75}Cu_{0.25}O₂ solid solution series.

FIG. 3. X-ray diffraction patterns for materials in the Li_{1.2}Mn_{0.4}Ni_{0.4-x}CoₓO₂ (0≦x≦0.4) series.

FIG. 4. First three room temperature charge-discharge cycles of materials in the Li_{1.2}Mn_{0.4}Ni_{0.4-x}CoₓO₂ series calcined at 800° C. Cycling was carried out between 2.0-4.6V at 10 mA/g.

FIG. 5. Discharge capacities for materials in the series L_{1.2}Mn_{0.4}Ni_{0.4-x}CoₓO₂ calcined at 740° C. as calculated from the mass of the lithium metal oxide before charging and as a value normalized to the transition metal content.

FIG. 6. Discharge capacities for materials in the series Li_{1.2}Mn_{0.4}Ni_{0.4-x}CoₓO₂ calcined at 800° C. as calculated from the mass of the lithium metal oxide before charging and as a value normalized to the transition metal content.

FIG. 7. Discharge capacities for materials in the series Li_{1.2}Mn_{0.4}Ni_{0.4-x}CoₓO₂ calcined 900° C. as calculated from the mass of the lithium metal oxide before charging and as a value normalized to the transition metal content. A rate excursion to 30 mA/g was carried out on Li_{1.2}Mn_{0.4}Cu_{0.4}O₂ for the 3 cycles as indicated.

FIG. 8. Capacities and average discharge voltage of Li_{1.2}Mn_{0.4}Ni_{0.3}Cu_{0.1}O₂ calcined at 800° C. when cycled at 55° C. as calculated from the mass of the lithium metal oxide before charging and as a value normalized to the transition metal content.

FIG. 9. X-ray diffraction patterns for materials in the Li₂MnO₃—LiNi_{0.5}Cu_{0.5}O₂ solid solution series calcined at 800° C.

FIG. 10. Discharge capacities for materials in the Li₂MnO₃—LiNi_{0.5}Cu_{0.5}O₂ solid solution series calcined at 800° C.

FIG. 11. X-ray diffraction patterns of a number of substituted analogues calcined at 800° C.

FIG. 12. Charge-discharge voltage curve for different materials calcined at 800° C. during the 30th cycle.

### DETAILED DESCRIPTION OF THE INVENTION

The capacities observed in the materials according to the invention are anomalously large in relation to their composition and the conventional views of accessible oxidation states. This is clearly illustrated by compositions that are solid solutions between Li₂MnO₃ and LiCoO₂ in which the cobalt is in the trivalent state.

For compositions in the series Li_{1.2}Mn_{0.4}Ni_{0.4-x}CoₓO₄. ie, wherein the general formula Li_{i+y/3}Mn_{2y/3}M_{(i-y)}O₂, y=0.6, the theoretical capacities should be:

a. Mn⁴⁺+M³⁺→Mn⁴⁺+M⁴⁺ 125 mAh/g

In the case of Li_{1.2}Mn0.4Cu_{0.4}O₂ calcined at 900° C. taper-charged at low current to 4.6V, the first charge capacity was found to be 345 mAh/g, leaving a discrepancy of 220 mAh/g. Assuming that the oxidised species is oxide rather than other cell components, this would lead to:

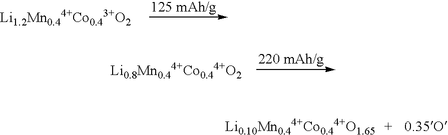

Li_{0.1}Mn_{0.4}Cu_{0.4}O_{1.65} can be equivalently described as Li_{0.125}Mn_{0.5}Cu_{0.5}O₂, which would yield a theoretical discharge capacity of approximately 240 mAh/g when correcting for the mass of the original active material. This mechanism would account for the different voltage profiles that the materials exhibit from cycle 2 onwards. An interesting observation is that the voltage curve of Li_{1.2}Mn0.4Cu_{0.402} after 2 full cycles is remarkably similar to that observed for LiCo_{0.5}Mn_{0.5}O₂ [Kajiyama et al, Solid State Ionics, v149 (2002) 39-45], the small low voltage feature early in the charge curve being common to both materials. In addition, the voltage curve of Li_{1.2}Mn_{0.4}Ni_{0.4}O₂ once the formation step is finished is similar to that observed for LiNi_{0.5}Mn_{0.5}O₂ [Makimura and Ohzuku, Journal of Power Sources, v119-121 (2003) 156-160].

After the formation step of charging to a voltage higher than 4.4 volts, the cathode materials can cycle with up to 95-98% reversibility over an extended period of time. This is significantly better behaviour than LiₓMn_{0.5}Cu_{0.5}O₂ prepared by chemical means, and is reminiscent of LiMn₂O₄ spinel produced in-situ by cycling o-LiMnO₂ [Gummow et al, Materials Research Bulletin, v28 (1993) 1249-1256]. The discharge capacity and capacity retention of the Al-doped material (given in table 1) are exceptionally good assuming in-situ formation of LiNi_{0.5}Co_{0.375}Al_{0.25}O₂, with a theoretical capacity of 204 mAh/g

The inclusion of Mn⁴⁺ has been reported to increase thermal stability, voltage stability, high temperature cycleability and discharge capacities.

Some of the more complex materials made have 5 different species sharing a single crystallographic site. Many standard synthetic techniques would not provide sufficient homogeneity to achieve a single-phase material. The synthetic techniques used to date to achieve this level of homogeneity are a chelation-based combined dispersion/combustion technique and a high energy ball-milling approach. The chelation method has been modified from the sucrose-based synthesis originally reported in the literature [Das, Materials Letters, v47 (2001), 344-350], and is easily capable of producing complex oxide materials with crystallites of sizes<100 nm.

The following examples of lithium metal oxide positive electrodes for a non-aqueous lithium cell having a Li₂MnO₃-type crystal structure and a general formula Li_{1+y/3}Mn_{2y/3}M_{(1-y)}O₂ where 0<y<1, manganese is in the 4+ oxidation state, and M is one or more transition metal or other metal cations having appropriate ionic radii, but not solely Ni or Cr, describe the principles of the invention as contemplated by the inventors, but they are not to be construed as limiting examples.

### EXAMPLE 1

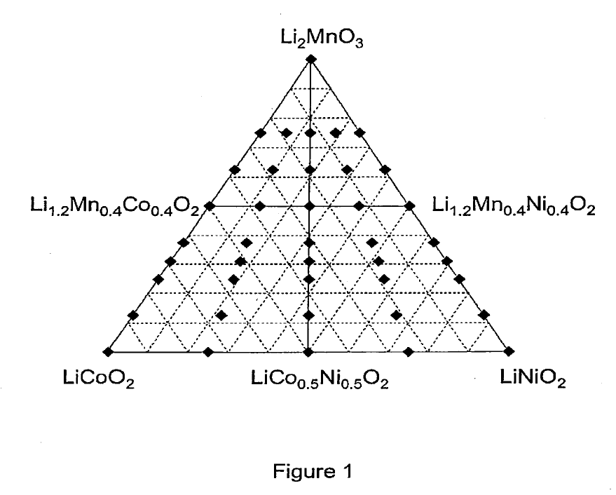

This example describes the typical synthesis route of materials in the (1−x)Li₂MnO₃: xLiNi_{1-y}Co_{y}O₂ (0≦x≦1; 0≦y≦1) solid solution series, wherein the general formula Li_{i+y/3}Mn_{2y/3}M_{(1-y)}O₂, M is Ni/Co. Mn(NO₃)₂.4H₂O, Ni(NO₃)₂.6H₂O, Co(NO₃)₂.H₂O and LiNO₃ were dissolved fully in water in the required molar ratios. Sucrose was added in an amount corresponding to greater than 50% molar quantity with regard to the total molar cation content. The pH of the solution was adjusted to pH 1 with concentrated nitric acid. The solution was heated to evaporate the water. Once the water had mostly evaporated the resulting viscous liquid was further heated. At this stage the liquid foamed and began to char. Once charring was complete the solid carbonaceous matrix spontaneously combusted. The resulting ash was calcined in air at 800° C., 740° C. or 900° C. for 6 hours. FIG. 1 shows the ternary phase diagram describing the (1−x) Li₂MnO₃: x LiNi_{1-y}Co_{y}O₂ solid solution series, with the materials synthesized being indicated by black diamonds.

The materials were analyzed with an X-ray powder diffractometer using CuKα radiation. The ash precursors were found to contain unreacted Li₂CO₃. However, after calcination at 800° C. in air for 6 hours, there was no longer any evidence of Li₂CO₃ in the diffraction patterns of the product materials.

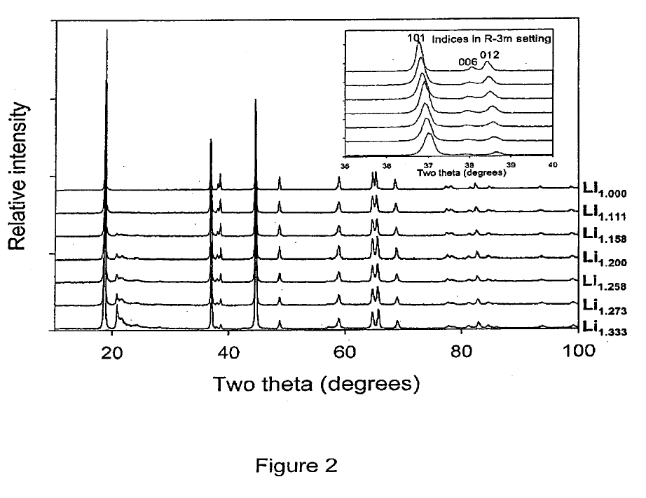

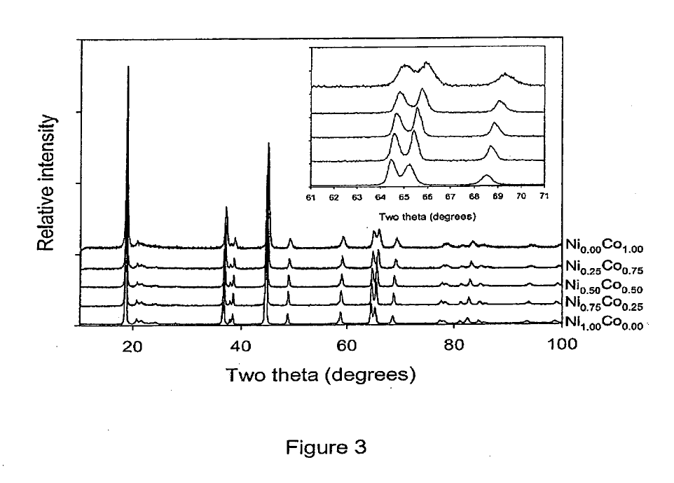

FIGS. 2 and 3 show the X-ray diffraction patterns for materials in the (1−x)Li₂MnO₃:LiNi_{0.75}Cu_{0.25}O₂ (0≦x≦1) and Li_{1.2}Mn_{0.4}Ni_{0.4-x}CoₓO₂ (0≦x≦0.4). It is noted that the latter formula is within the scope of the general formula Li_{i+y/3}Mn_{2y/3}M_{(1-y)}O₂ ie, when y=0.6. These series correspond to the vertical and horizontal tie-lines shown in FIG. 1. There are no visible reflections due to Li₂CO₃ in any of the calcined materials, indicating that all of the materials were fully reacted.

The materials in FIG. 2 show a change from Li₂MnO₃-like patterns to layered R-3m-like patterns.

The materials in FIG. 3 all retain features of a Li₂MnO₃-like pattern.

As mentioned above, in the Li_{i+y/3}Mn_{2y/3}M_{(1-y)}O₂, wherein 0<y<1, the preferred values for y are as follows. In preferred compositions, y is in the range 0.18≦y≦ 0.82. In more preferred compositions, 0.33≦y≦0.82. In most preferred compositions, 0.47≦y≦0.82. These values for y are obtained from FIG. 2, which shows XRD patterns for solid solutions of Li₂MnO₃ and LiNi_{0.75}Cu_{0.25}O₂, which can be described in terms of the general formula Li_{i+y/3}Mn_{2y/3}M_{(1-y)}O₂ in which M is Ni/Co in the ratio of 3:1

More specifically, by simple mathematical calculations, for y=0 at the lower limit of the value for y, the amount of Li is 1.0. At the upper limit for the value of y of 1, the amount of Li is 1.33. However, Li_{1.33}MnO₂ is equivalent to the known material Li₂MnO₃.

For y=0.18, the amount of Li is 1.06.

For y=0.33, the amount of Li is 1.11.

For y=0.47, the amount of Li is 1.158.

For y=0.6, the amount of Li is 1.20.

For y=0.77, the amount of Li is 1.258.

For y=0.82, the amount of Li is 1.273

For y=1, the amount of Li is 1.333

As shown in FIG. 2, the XRD patterns from Li=1.158 to 1.33 (i.e. from y=0.47 to y=1.0), show clear evidence of the additional reflections between 20 and 30 degrees in 2theta, that are indicative of the Li₂MnO₃-type structure. Li=1.33 corresponds to the end member of the solid solution series Li₂MnO₃. The preferred range of y is from 0.18 to less than 1.0. The most preferred range of y is from 0.47 to 0.82.

At Li=1.0 (y=0), the material is simply LiNi_{0.75}Cu_{0.25}O₂. with a R-3m crystal structure. Is this why we do not include y=0 as the upper limit, and why we chose y=0.82 as the preferred upper limit. At y=1, we have the known end member of the solid solution, Li₂MnO₃. The next closest value of y for which we have XRD data shown is y=0.82.

At y=1.11, there is only a hint of the characteristic Li₂MnO₃-type crystal structure. Hence, the more preferred lower limit of y is 0.33.

The Li₂MnO₃ crystal structure can be viewed as a variant of the R-3m structures of LiCoO₂, LiNiO₂ and LiCrO₂. This R-3m crystal structure often described as an O3 structure. The main difference between the R-3m and Li₂MnO₃-type structures is that in the Li₂MnO₃-type structure there is a higher degree of cation ordering.

### EXAMPLE 2

Electrodes were fabricated from materials prepared as in example 1 by mixing approximately 78 wt % of the oxide material, 7 wt % graphite, 7 wt % Super S, and 8 wt % poly(vinylidene fluoride) as a slurry in 1-methyl-2-pyrrolidene (NMP). The slurry was then cast onto aluminum foil. After drying at 85° C., and pressing, circular electrodes were punched. The electrodes were assembled into electrochemical cells in an argon-filled glove box using 2325 coin cell hardware. Lithium foil was used as the anode, porous polypropylene as the separator, and 1M LiPF₆ in 1:1 dimethyl carbonate (DMC) and ethylene carbonate (EC) electrolyte solution. A total of 70 μl of electrolyte was used to saturate the separator. The cells were cycled at constant current of 10 mA/g of active material between 2.0 and 4.6V at room temperature. The capacities observed on the first and thirtieth cycles are given in table 1.

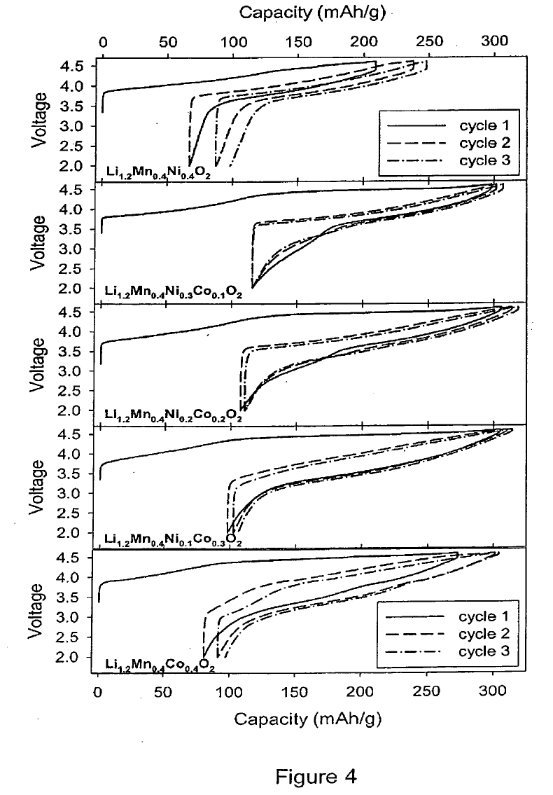

FIG. 4 shows the electrochemical behavior of the first 3 cycles of materials in the Li_{1.2}Mn_{0.4}Ni_{0.4-x}CoₓO₂ (0≦x≦0.4) series prepared as in example 1 and calcined at 800° C. It will be appreciated that this formula is within the scope of the general formula Li_{i+y/3}Mn_{2y/3}M₍₁₋₎O₂ ie. when y=0.6 and M is Ni/Co. The voltage curves in FIG. 4 show that a formation step occurs during early cycling. For x=0.1, 0.2 and 0.3, this formation is completed after the first cycle, after which the materials cycle with high capacity and reversibility. Consequently, the desired material is that formed during oxidation rather than the chemically synthesized composition. For x=0.4, this formation requires more than one cycle, with increased lithium extraction also on the second charge. The cell polarization of x=0.0, indicates that the formation is extremely slow, and would require higher voltages, or smaller particle size.

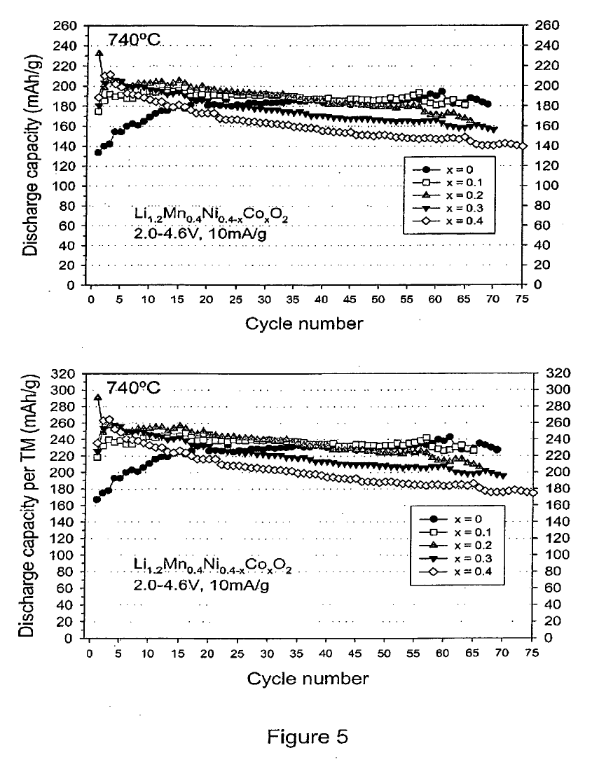

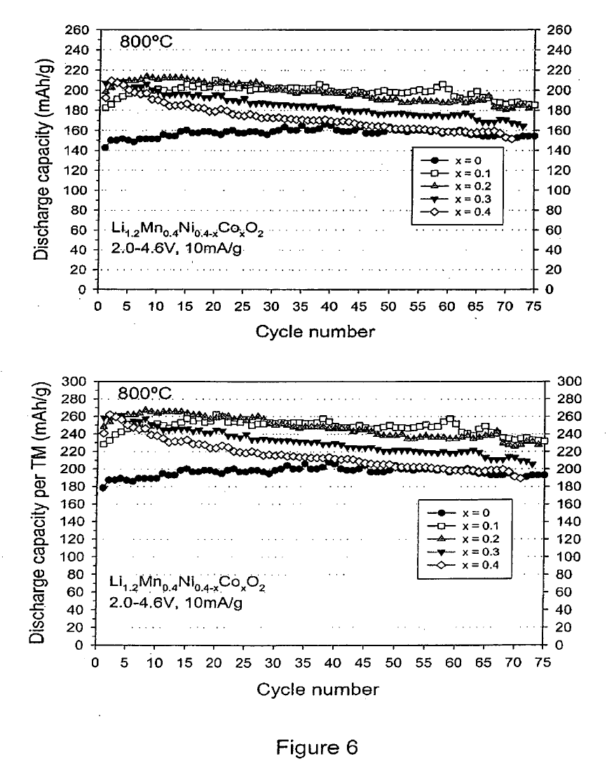

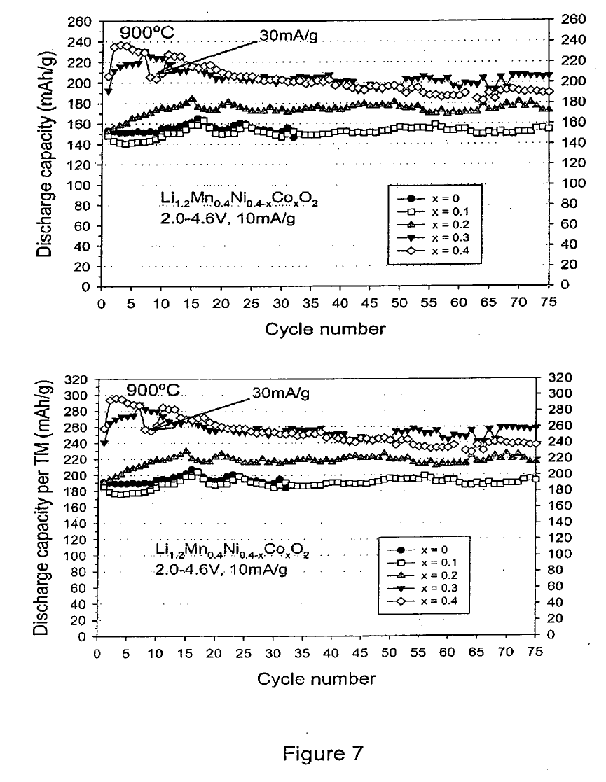

FIG. 5-7 show the discharge capacities of Li_{1.2}Mn_{0.4}Ni_{0.4-x}CoₓO₂ materials calcined at 740, 800 and 900° C. respectively. It can be seen that the trends in discharge capacity vary with both composition and calcination temperature. The materials described here contain substantially less transition metals than conventional lithium-battery cathode materials. Given that the transition metals content contributes substantially to the cost of production, it is useful to compare the capacities in terms of the transition metal (TM) content normally found in current lithium battery cathode materials, i.e. LiMO₂. Consequently, additional plots are shown in FIGS. 5-7, describing the discharge capacity per transition metal equivalent. In the case of the Li_{1.2}Mn0.4Ni_{0.4-x}CoₓO₂ series, the ratio of Li:TM is 1.2:0.8, as opposed to 1:1 in conventional lithium battery cathode materials, so there is a scaling factor of 1/0.8=1.25 in order to produce the capacity per TM equivalent. For another material in the (1−x)Li₂MnO₃: xLiNi_{1-y}Co_{y}O₂ (0≦x≦1; 0≦y≦1) solid solution series, e.g. Li_{1.158}Mn_{0.316}Ni_{0.263}Co_{0.263}O₂, the scaling factor would be 1/0.828=1.188.

An ultimate charged composition may be calculated using the total charge capacity taking into account any early cycling irreversibility, and results obtained from atomic absorption spectroscopy for the cation contents. Atomic absorption ratios were calculated such that the total cation content equals 2 in a LiMO₂ format. For materials in the series Li₂MnO₃:LiNi₁₋ₓCoₓO₂ (0≦x≦0.4) calcined at 800° C., the results of these calculations are shown in table 2.

The results show that the compositions with x=0.1, 0.2 and 0.3 produce charged materials with lithium contents <0.2, and x=0.4 very close to 0.2. The material with x=0.0 did not achieve the same extent of delithiation and exhibited lower capacities on cycling.

### EXAMPLE 3

Many lithium battery cathode materials do not perform well at elevated temperatures, their discharge capacities on extended cycling fading rapidly.

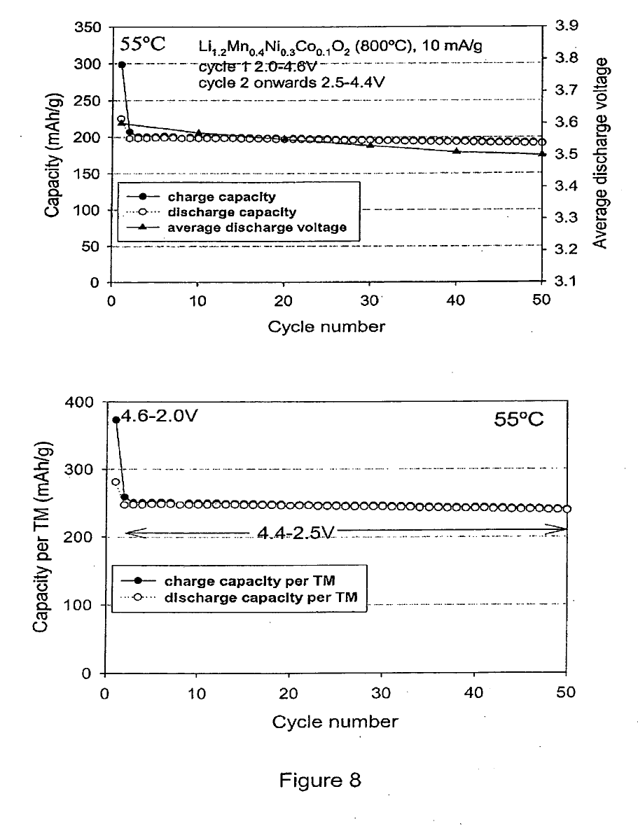

The electrochemical behavior of the materials of the invention were evaluated at elevated temperature. Identical cells were used to those at room temperature. FIG. 8 shows the discharge capacity of 800° C.-calcined Li_{1.2}Mn_{0.4}Ni_{0.3}Co_{0.1}O₂ at 55° C. The voltage limits after the first cycle were reduced to avoid electrolyte decomposition. The material exhibited very stable capacities with very high reversibility in cycle 2 onwards. The average discharge voltage also remained quite stable for 55° C. cycling.

### EXAMPLE 4

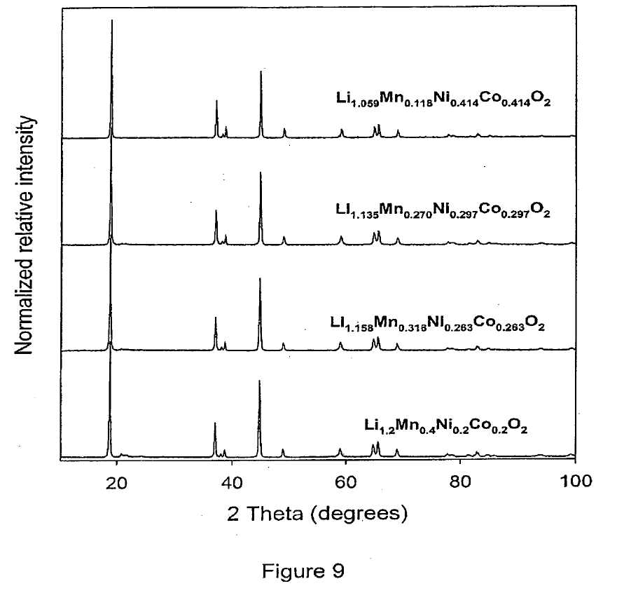

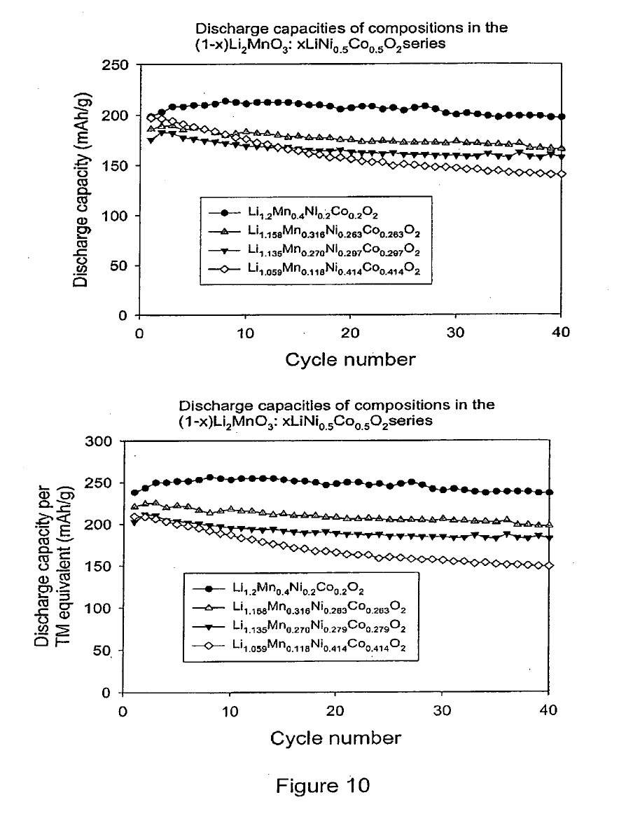

Electrochemical cells were fabricated as in example 2 from compositions in the series (1−x) Li₂MnO₃: x LiNi_{0.5}Co_{0.2} that were prepared as in example 1 and calcined at 800° C. These cells were tested as in example 2 between voltage limits of 2.0 and 4.6 volts. The diffraction patterns for various compositions in the series (1−x) Li₂MnO₃: x LiNi_{0.5}Cu_{0.5}O₂ are shown in FIG. 9 and the corresponding electrochemical performance is illustrated in FIG. 10. An additional plot corresponding to the discharge capacities normalized per transition metal is also shown in FIG. 10. The theoretical capacities based on conventional views of accessible oxidation states and structure as well as the accumulated charge and ultimate lithium content in the fully charged state are listed in table 3.

### EXAMPLE 5

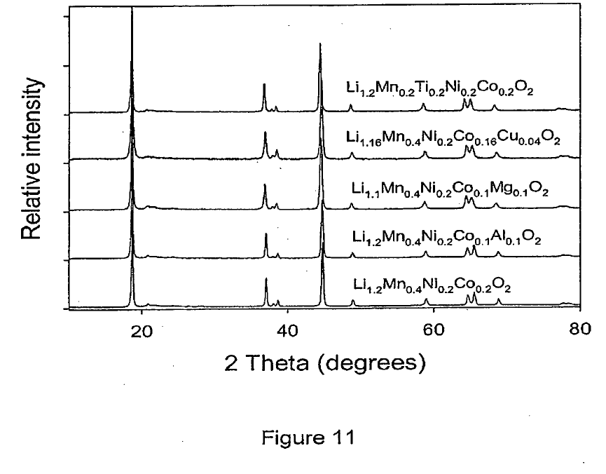

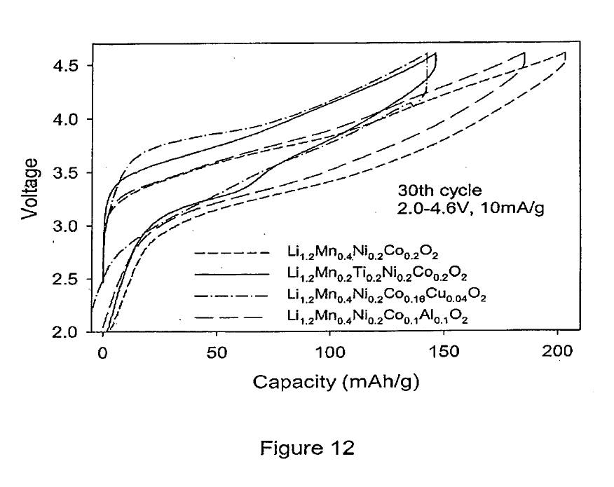

Compositions with additional substitutents have also been investigated. FIG. 11 shows that materials with Ti, Cu and Al substitution could also be produced single-phase. These materials were produced using the same chelation-based process, but with the addition of the required molar quantity of precursor. The precursors used were (NH₄)₂TiO(C₂H₄)₂.H₂O, Cu(NO₃)₂.3H₂O and Al(NO₃)₃.9H₂O. The discharge capacities obtained for the Al, Cu and Ti-substituted materials after the first and thirtieth cycles are tabulated in table 1. It can be seen that Cu and Ti-doping impacted the discharge capacities obtained, but these materials cycled with very stable capacity. Given the very high amount of Al doped into Li_{1.2}Mn_{0.4}Ni_{0.2}Cu_{0.1}Al_{0.1}O₂, the discharge capacities obtained are quite high. Such a high level of Al in a conventional lithium battery cathode material would be expected to impact severely on the discharge capacities obtained. FIG. 12 shows the charge-discharge voltage curves for the same materials on the 30th cycle. It can be seen that the Ti-doping has a particular effect on the discharge curve, with a distinct kink at approximately 3.3V. The Al-doping has the effect of increasing the average discharge voltage of the material. Given the very high amount of Al doped into Li_{1.2}Mn_{0.4}Ni_{0.2}Cu_{0.1}Al_{0.1}O₂, the discharge capacities obtained are quite high, with a discharge capacity of 186 mAh/g after 30 cycles.

The theoretical capacities, for the Al and Ti substituted materials, based on conventional views of accessible oxidation states and structure as well as the accumulated charge and ultimate lithium content in the fully charged state are listed in table 3.

### EXAMPLE 6

The use of nitrates is not necessary for the production of single phase Li_{1.2}Mn_{0.4}Ni_{0.3}Cu_{0.1}O₂. The X-ray diffraction verified that that single-phase materials can be produced using all acetate salts or a combination of lithium formate and metal acetate salts as precursors. All of the other processing conditions were identical to examples 1 and 2. The discharge capacities obtained using nitrates and lithium formate with acetates as the precursors are given in table 1. It can be seen that the performance is actually improved using the lithium formate with acetates. After 30 cycles the discharge capacity is approximately 20 mAh/g higher than using nitrate precursors.

### EXAMPLE 7

This example shows that materials with similar performance may be produced by methods other than a solution-based chelation mechanism. Li₂MnO₃ and LiCoO₂ were mixed in a 1:1 molar ratio, and milled in a high-energy ball-mill for a total of 9 hours. The resulting powder was calcined in air at 740° C. in air for 6 hours. X-ray diffraction of the materials both before and after calcination showed no indication of the presence of Li₂MnO₃. The material after calcination was single-phase and more crystalline than the milled precursor.

The discharge capacities, listed in table 1, obtained with the ball-mill produced material under the same cycling conditions as example 2 were substantially similar to those obtained with material produced using the solution-based chelation process.

TABLE 1
Discharge capacities at the first and thirtieth cycles for various
compositions of xLi₂MnO₃:(1 − x)LiMO₂. The capacities are
calculated first as mAh/g based as on the weight of the lithium
metal oxide as prepared, before in-situ oxidation, and then
normalized to a per transition metal capacity.

| | | 1st | | 30th |
|---|---|---|---|---|
| | 1st | discharge | 30th | discharge |
| | discharge | capacity | discharge | capacity |
| | capacity | per TM | capacity | per TM |
| Composition | (mAh/g) | (mAh/g) | (mAh/g) | (mAh/g) |
| EXAMPLE 2 - 740° C. | | | | |
| Li_{1.2}Mn_{0.4}Ni_{0.4}O₂ | 134 | 168 | 184 | 230 |
| Li_{1.2}Mn_{0.4}Ni_{0.3}Co_{0.1}O₂ | 175 | 219 | 192 | 240 |
| Li_{1.2}Mn_{0.4}Ni_{0.2}Co_{0.2}O₂ | 232 | 290 | 192 | 240 |
| Li_{1.2}Mn_{0.4}Ni_{0.1}Co_{0.3}O₂ | 180 | 225 | 177 | 222 |
| Li_{1.2}Mn_{0.4}Co_{0.4}O₂ | 189 | 236 | 164 | 205 |
| EXAMPLE 2 - 800° C. | | | | |
| Li_{1.2}Mn_{0.4}Ni_{0.4}O₂ | 143 | 179 | 159 | 199 |
| Li_{1.2}Mn_{0.4}Ni_{0.3}Co_{0.1}O₂ | 183 | 229 | 202 | 253 |
| Li_{1.2}Mn_{0.4}Ni_{0.2}Co_{0.2}O₂ | 199 | 249 | 200 | 250 |
| Li_{1.2}Mn_{0.4}Ni_{0.1}Co_{0.3}O₂ | 207 | 259 | 186 | 233 |
| Li_{1.2}Mn_{0.4}Co_{0.4}O₂ | 193 | 241 | 172 | 215 |
| EXAMPLE 2 - 900° C. | | | | |
| Li_{1.2}Mn_{0.4}Ni_{0.4}O₂ | 154 | 193 | 152 | 190 |
| Li_{1.2}Mn_{0.4}Ni_{0.3}Co_{0.1}O₂ | 148 | 185 | 147 | 184 |
| Li_{1.2}Mn_{0.4}Ni_{0.2}Co_{0.2}O₂ | 152 | 190 | 174 | 218 |
| Li_{1.2}Mn_{0.4}Ni_{0.1}Co_{0.3}O₂ | 192 | 240 | 203 | 254 |
| Li_{1.2}Mn_{0.4}Co_{0.4}O₂ | 206 | 258 | 203 | 254 |
| EXAMPLE 3 | | | | |
| Li_{1.2}Mn_{0.4}Ni_{0.3}Co_{0.1}O₂ (55° C.) | 225 | 281 | 195 | 244 |
| EXAMPLE 4 | | | | |
| Li_{1.158}Mn_{0.316}Ni_{0.263}Co_{0.263}O₂ | 186 | 221 | 173 | 205 |
| Li_{1.135}Mn_{0.270}Ni_{0.297}Co_{0.298}O₂ | 175 | 202 | 159 | 184 |
| Li_{1.06}Mn_{0.12}Ni_{0.41}Co_{0.41}O₂ | 197 | 209 | 147 | 156 |
| LiNi_{0.5}Co_{0.5}O₂ | 162 | 162 | 143 | 143 |
| EXAMPLE 5 | | | | |
| Li_{1.2}Mn_{0.2}Ti_{0.2}Ni_{0.2}Co_{0.2}O₂ | 156 | 195 | 175 | 219 |
| Li_{1.2}Mn_{0.4}Ni_{0.2}Co_{0.1}Al_{0.1}O₂ | 179 | 224 | 186 | 233 |
| Li_{1.16}Mn_{0.4}Ni_{0.2}Co_{0.16}Cu_{0.04}O₂ | 150 | 188 | 150 | 188 |
| EXAMPLE 6 | | | | |
| nitrates | 208 | 260 | 186 | 233 |
| Li formate + acetates | 189 | 236 | 215 | 269 |
| EXAMPLE 7 | | | | |
| Li_{1.2}Mn_{0.4}Co_{0.4}O₂ (milled) | 196 | 245 | 167 | 209 |
| Li_{1.2}Mn_{0.4}Co_{0.4}O₂ (sucrose) | 188 | 235 | 164 | 205 |

TABLE 2
Tabulation of lithium contents for materials in the series Li₂MnO₃:
LiNi₁₋ₓCoₓO₂ (0 ≦ x ≦ 0.4) calcined at 800° C., as
made and after in-situ formation in an electrochemical cell.

| | | Accumulated | Ultimate |
|---|---|---|---|
| | Li content | charge | charged Li |
| X | (AA) | (mAh/g) | content |
| 0.0 | 1.162 | 263 | 0.32 |
| 0.1 | 1.146 | 298 | 0.20 |
| 0.2 | 1.174 | 308 | 0.20 |
| 0.3 | 1.158 | 334 | 0.09 |
| 0.4 | 1.172 | 301 | 0.20 |

TABLE 3
Tabulation of theoretical capacities, accumulated charge and lithium
contents after in-situ formation in an electrochemical cell for various
compositions in the series xLi₂MnO₃:(1 − x)LiMO₂ calcined
at 800° C..

| | Conventional | | |
|---|---|---|---|
| | theoretical | Actual | Ultimate |
| | charge | accumulated | charged |
| | capacity | charge | Li |
| Nominal composition | (mAh/g) | (mAh/g) | content |
| Li_{1.2}Mn_{0.2}Ti_{0.2}Ni_{0.2}Co_{0.2}O₂ | 127 | 318 | 0.20 |
| Li_{1.2}Mn_{0.4}Ni_{0.2}Co_{0.1}Al_{0.1}O₂ | 97 | 298 | 0.28 |
| Li_{1.158}Mn_{0.316}Ni_{0.263}Co_{0.263}O₂ | 160 | 301 | 0.17 |
| Li_{1.135}Mn_{0.270}Ni_{0.297}Co_{0.298}O₂ | 178 | 323 | 0.05 |
| Li_{1.06}Mn_{0.12}Ni_{0.41}Co_{0.41}O₂ | 235 | 273 | 0.10 |

1. A lithium-metal-oxide composition formed as a solid solution of LiMnO₃ and LiMO₂ having a Li₂MnO₃-type crystallographic structure and the general formula Li_{1+y/3}Mn_{2y/3}M_{(1-y)}O₂ I, wherein 0<y<1, manganese is in the 4+ oxidation state, M is one or more transition metal or other cations which have an appropriate ionic radii to be inserted into the structure without unduly disrupting it, but not solely Ni or Cr, and M has an average oxidation state of +3.

2. A composition according to claim 1, wherein M is chosen from all of the other first row transition metals: Ti, V. Cr, Fe, Co, Ni and Cu, and other cations with appropriate sized ionic radii: Al, Mg, Mo, W, Ta, Si, Sn, Zr, Be, Ca, Ga, and P.

3. A composition according to claim 1, wherein M is one or more transition metal or other cations chosen from the other first row transition metals: Ti, V, Cr, Fe, Co, Ni and Cu, and other metal cations such as Al, Mo, W, Ta, Ga and Zr, and is not solely Ni²⁺ or Cr³⁺, and when M is a single cation it is in the 3+ oxidation state.

4. A composition according to claim 1, wherein M is one or more transition metal or other metal cations chosen from the first row transition metals and Al.

5. A composition according to claim 1, wherein the general formula, 0.18≦y≦0.82.

6. A composition according to claim 1, wherein the general formula, 0.33≦y≦0.82.

7. A composition according to claim 1, wherein the general formula, 0.47≦y≦0.82.

8. A lithium-metal-oxide composition formed as a solid solution of LiMnO₃ and LiMO₂ having a Li₂MnO₃-type crystallographic structure and the general formula Li_{i+y/3}Mn_{2y/3}M_{(1-y)}O₂ wherein 0<y<1, manganese is in the 4+ oxidation state, M is one or more transition metal or other cations which have an appropriate ionic radii to be inserted into the structure without unduly disrupting it, but not solely Ni or Cr, and M has an average oxidation state of +3., exhibiting anomalously large reversible capacities after charging at least once to voltages greater than about 4.4 volts versus Li/Li⁺.

9. A composition according to claim 8, wherein M is chosen from all of the other first row transition metals: Ti, V, Cr, Fe, Co, Ni and Cu, and other cations with appropriate sized ionic radii: Al, Mg, Mo, W, Ta, Si, Sn, Zr, Be, Ca, Ga, and P.

10. A composition according to claim 8, wherein M is one or more transition metal or other cations chosen from the other first row transition metals: Ti, V, Cr, Fe, Co, Ni and Cu, and other metal cations such as Al, Mo, W, Ta, Ga and Zr, and is not solely Ni²⁺ or Cr³⁺, and when M is a single cation it is in the 3+ oxidation state.

11. A composition according to claim 8, wherein the voltage range is 4.4 to 5.2 V.

12. A composition according to claim 8, wherein the voltage range is 4.4 to 4.6.

13. A composition according to claim 1, wherein the general formula y is 0.6.

14. A composition according to claim 12, wherein the general formula is Li_{1.2}Mn_{0.4}Ni_{0.4-x}CoₓO₂, wherein x is 0.1 to 0.4.

15. A process for making a lithium-metal-oxide composition formed as a solid solution of LiMnO₃ and LiMO₂ having a Li₂MnO₃-type crystallographic structure and the general formula Li_{1+y/3}Mn_{2y/3}M_{(1-y)}O₂ I, wherein 0<y<1, manganese is in the 4+ oxidation state, M is one or more transition metal or other cations which have an appropriate ionic radii to be inserted into the structure without unduly disrupting it, but not solely Ni or Cr, and M has an average oxidation state of +3, comprising
(a) providing as starting material, metal ions in the form of water soluble salts such as nitrate salts, oxalate salts, or acetate salts in the required stoichiometries,
(b) adding sucrose in aqueous solution in a molar excess amount e.g. calculated to be a 4:1 molar excess over the metal cations,
(c) dissolving the solids in an aqueous solvent e.g. de-ionized water,
(d) adding a strong acid e.g. concentrated nitric acid, until the pH of the solution is ≦1,
(e) heating the solution e.g. on a hotplate, to evaporate the water,
(f) once the solution starts to become viscous, increasing the heating to decompose the salts and eventually char the sucrose,
(g) continuing the heating until the char dries out and is eventually combusted,
(h) once combustion has finished, collecting the ashes and used as a precursor, and
(i) firing the precursor e.g. in flowing air at high temperature e.g. 740, 800 or 900° C. for 6 hours.

16. A process according to claim 15, wherein M is chosen from all of the other first row transition metals: Ti, V, Cr, Fe, Co, Ni and Cu, and other cations with appropriate sized ionic radii: Al, Mg, Mo, W, Ta, Si, Sn, Zr, Be, Ca, Ga, and P.

17. A process according to claim 15, wherein M is one or more transition metal or other cations chosen from the other first row transition metals: Ti, V, Cr, Fe, Co, Ni and Cu, and other metal cations such as Al, Mo, W, Ta, Ga and Zr, and is not solely Ni²⁺ or Cr³⁺, and when M is a single cation it is in the 3+ oxidation state.

18. A process according to claim 15, wherein the general formula 0.47≦y≦0.82.

19. A process according to claim 15, wherein the general formula y=0.6, and wherein the general formula is Li_{1.2}Mn_{0.4}Ni_{0.4-x}CoₓO₂, wherein x is 0.1 to 0.4

20. The use of a composition according to claim 1, as positive electrode in a non-aqueous lithium cell or battery, such as a lithium ion cell.
